(19) United States
(12) Patent Application Publication
(10) Pub. No.: US 2014/0253711 A1
(43) Pub. Date: Sep. 11, 2014

(54) AGILE NON-CONTACT BIOMETRIC SENSOR

(71) Applicant: ADVANCED OPTICAL SYSTEMS, INC., Huntsville, AL (US)

(72) Inventors: Michael Kevin Balch, Madison, AL (US); Jonathan Allan Berry, Huntsville, AL (US); Stephen Harris Fox, Madison, AL (US); Stephen Riley Granade, Madison, AL (US); Richard Leon Hartman, Huntsville, AL (US); Keith George Savas, Huntsville, AL (US); Kevin Deane Spradley, Huntsville, AL (US)

(73) Assignee: ADVANCED OPTICAL SYSTEMS, INC., Huntsville, AL (US)

(21) Appl. No.: 14/198,887

(22) Filed: Mar. 6, 2014

Related U.S. Application Data
(60) Provisional application No. 61/774,016, filed on Mar. 7, 2013.
(60) Provisional application No. 61/913,476, filed on Dec. 9, 2013.

(51) Int. Cl. G06K 9/00

(52) U.S. Cl. CPC G06K 9/00013
USPC 348/77

(57) ABSTRACT

Exemplary embodiments include an agile non-contact biometric sensor apparatus, having a sensor that monitors a field of view for a user, an imaging system that captures one or more pieces of biometric information from the user, and a pan-tilt device that orients the imaging system to a location of the user in the field of view detected by the sensor.

### CROSS-REFERENCE TO RELATED APPLICATIONS

The present application claims the benefit of provisional application No. 61/774,016 filed Mar. 7, 2013, the contents of which is hereby incorporated by reference in its entirety. The present application also claims the benefit of provisional application No. 61/913,476 filed Dec. 9, 2013, the contents of which is also hereby incorporated by reference in its entirety.

### BACKGROUND

This application relates to biometric sensors, specifically an agile non-contact biometric sensor that is capable of capturing fingerprint data from a hand placed anywhere in a large field of view.

The capture and use of biometric data such as fingerprints is becoming increasingly popular for a variety of identification and security applications. Traditional methods of acquiring fingerprint data require either contact or close proximity of the finger to a sensor. Historically, the most common method of capturing fingerprint data is the use of ink on paper.

Recently, improved contactless fingerprint acquisition and processing systems have been developed which are capable of acquiring fingerprint data from fingers that are located at a distance from the sensor. In general, these systems require that the desired finger be placed in a particular position, which is at a known distance from the sensor.

### SUMMARY OF THE INVENTION

Exemplary embodiments include an agile non-contact biometric sensor apparatus, including a sensor that monitors a field of view for a user, an imaging system that captures one or more pieces of biometric information from the user, and a pan-tilt device that orients the imaging system to a location of the user in the field of view detected by the sensor.

Another exemplary embodiment includes a method for capturing fingerprint data with an agile non-contact biometric sensor apparatus. The method includes monitoring a field of view for a hand by a sensor of the agile non-contact biometric sensor apparatus. Based on determining that the hand is present in the field of view, the method includes receiving a location of the hand from the sensor, pointing an imaging system of the agile non-contact biometric sensor apparatus at the location of the hand and capturing fingerprint data from the hand with the imaging system.

Additional exemplary embodiments include a computer program product having a non-transitory computer readable medium storing instructions for causing a computer to perform a method for capturing fingerprint data with an agile non-contact biometric sensor apparatus. The method includes monitoring a field of view for a hand by a sensor of the agile non-contact biometric sensor apparatus. Based on determining that the hand is present in the field of view, the method includes receiving a location of the hand from the sensor, pointing an imaging system of the agile non-contact biometric sensor apparatus at the location of the hand and capturing fingerprint data from the hand with the imaging system.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 illustrates an schematic view of an agile non-contact biometric sensor system in accordance with an exemplary embodiment;

FIG. 2 illustrates a block diagram of an agile non-contact biometric sensor apparatus in accordance with an exemplary embodiment;

FIG. 3A illustrates an schematic view of an agile non-contact biometric sensor apparatus in accordance with an exemplary embodiment;

FIG. 3B illustrates an schematic view of an agile non-contact biometric sensor apparatus in accordance with an exemplary embodiment;

FIG. 4 illustrates a flowchart diagram of a method for capturing fingerprint data with an agile non-contact biometric sensor apparatus in accordance with an exemplary embodiment;

FIG. 5 illustrates a flowchart diagram of a method for enrollment in a biometric database using an agile non-contact biometric sensor apparatus in accordance with an exemplary embodiment;

FIG. 6 illustrates a system level diagram of an exemplary contactless fingerprint acquisition and processing system; and

FIG. 7 illustrates an exemplary embodiment of a system for acquiring and processing contactless finger/palm prints.

### DETAILED DESCRIPTION

Exemplary embodiments include systems and methods for acquiring fingerprint data with agile non-contact sensors. In exemplary embodiments, the agile non-contact sensors do not require contact with the fingers and are capable of capturing fingerprint data when the presence of a hand is detected in a large field of view. It will be appreciated that the exemplary embodiments described herein apply to apparatuses that can acquire fingerprints from relatively large distances such as up to two meters away from the apparatus, and apparatuses that can acquire fingerprints in closer proximity such as 2-6 inches (approximately 50 mm to 150 mm) away from the apparatus. It is understood that these ranges are just examples and are not limiting in any way. It is further understood that the term “fingerprint” includes any identifying impression of the fingers, thumb, palm, hand or combinations thereof. The terms may be used interchangeably, but are understood to cover the individual fingers, thumb, palm, hand or combinations as described.

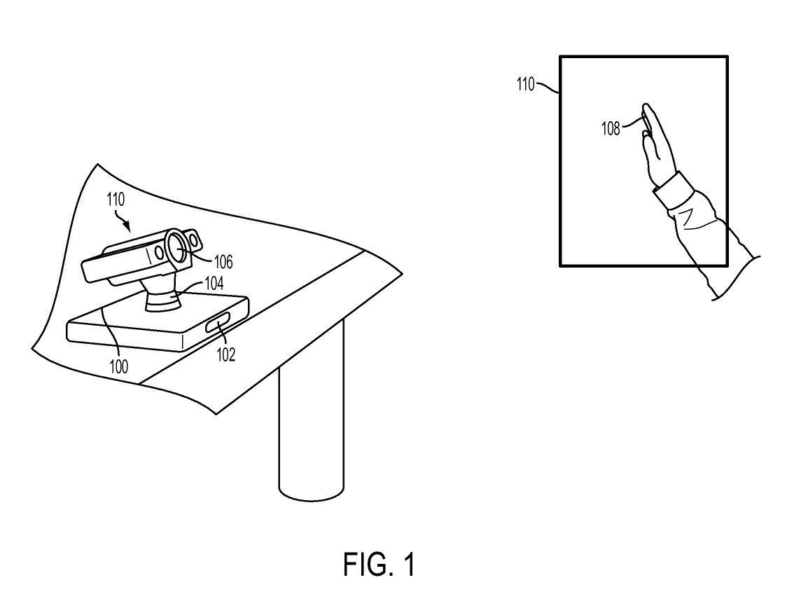

FIG. 1 illustrates an agile non-contact biometric sensor system 100 in accordance with an exemplary embodiment. In exemplary embodiments, the agile non-contact biometric sensor system 100 includes a sensor 102 configured to detect the presence and position of a hand in a field of view 110. In exemplary embodiments, the sensor 102 may be a 3-D gaming sensor, such as the Xtion Pro Live® by ASUS. The agile non-contact biometric sensor system 100 also includes an imaging system 106 that is mounted on a pan-tilt device 104. In exemplary embodiments, the imaging system 106 is a contactless fingerprint acquisition device, such as that disclosed in U.S. patent application Ser. No. 13/268,103, the entirety of which is hereby incorporated by reference. In exemplary embodiments, the pan-tilt device 104 may be any suitable pan and tilt device, such as the MX-64 pan-tilt device by Dynamix. In exemplary embodiments, the sensor 102 of the agile non-contact biometric sensor system 100 is configured to detect the presence of a hand 108 inside of a field of view 110. Upon detection of the hand 108, the sensor 102 determines the location of the detected hand 108 in the field of view 110 and the pan-tilt device 104 responsively orients the imaging system 106 to capture fingerprint data from the hand 108.

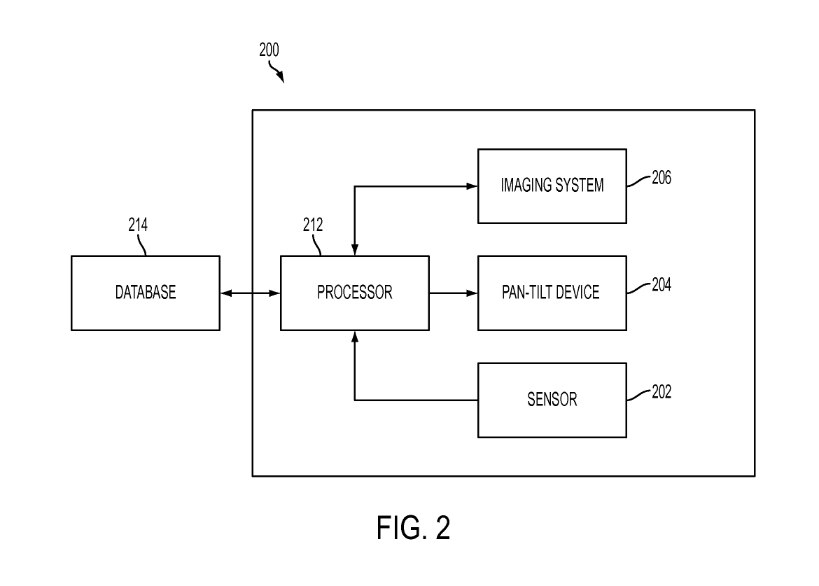

FIG. 2 illustrates block diagram of an agile non-contact biometric sensor apparatus 200 in accordance with an exemplary embodiment. In exemplary embodiments, the agile non-contact biometric sensor apparatus 200 includes a sensor 202, a pan-tilt device 204 and imaging system 206 and a processor 212. In one embodiment, the sensor 202 is configured to detect the presence of a hand inside of a field of view and to responsively provide a signal to the processor 212 that indicates the location of the hand in the field of view.

In one embodiment, the pan-tilt device 204 receives control signals from the processor 212 and responsively adjusts the position of the imaging system 206, which is mounted on the pan-tilt device 204. Likewise, the imaging system 206 receives control signals from the processor 212 and responsively adjusts one or more operation parameters of the imaging system 206. In exemplary embodiments, the one or more operation parameters of the imaging system 206 include, but are not limited to, an optical zoom, a digital zoom, gain, gamma, and white balance, and the like. In another embodiment, the imaging system 206 is stationary and the pan-tilt device 204 includes a movable mirror. In this embodiment, the mirror of the pan-tilt device 204 is located in front of the imaging system 206 and by adjusting the tilt of the mirror the field of view of the view of the imaging system 206 can be adjusted.

In exemplary embodiments, the processor 212 of the agile non-contact biometric sensor apparatus 200 is configured to control the operation of the sensor 202, the pan-tilt device 204 and the imaging system 206 using a variety of algorithms. In one embodiment, the processor 212 may include multiple processing units that are disposed in and configured to operate the sensor 202, the pan-tilt device 204 and the imaging system 206. In another embodiment, a single processor 212 may be configured to operate the sensor 202, the pan-tilt device 204 and the imaging system 206.

In exemplary embodiments, the processor 212 of the agile non-contact biometric sensor apparatus 200 is configured to execute a sensing algorithm that uses the sensor 202 to detect the existence of a person, find their hand, and provide location information for the detected person and hand. In one embodiment, the sensing algorithm may be configured to not provide the location information until it detects that the hand is raised above the waist. In exemplary embodiments, the processor 212 is also configured to execute a drive algorithm that receives location information from the sensing algorithm and drives the pan-tilt device 204 in order to point the imaging system 206 to the hand and then the finger.

In exemplary embodiments, the processor 212 of the agile non-contact biometric sensor apparatus 200 is configured to execute a fingerprint capture algorithm which operates the imaging system 206. The fingerprint capture algorithm uses location information from the sensor 202 to set its initial focus. The fingerprint capture algorithm isolates the hand and then provides updated location information to drive algorithm, which is used to adjust the positioning of the imaging system 206 center the fingertip image. In exemplary embodiments, the fingerprint capture algorithm captures a plurality of images of the fingerprint, selects the image with the best focus, and converts the image to a fingerprint using algorithms as described in U.S. patent application Ser. No. 13/268,103. In exemplary embodiments, the processor 212 may also execute a matching algorithm that compares the fingerprint to a database 214 which includes known fingerprints.

In exemplary embodiments, the imaging system 206 is configured capture fingerprint data from one or more captured images. In exemplary embodiments, the imaging system 206 may include a focus algorithm designed to ensure proper focus of the capture images. The focus algorithm may include, but is not limited to, a trap focus, a stack focus, a region of interest focus, a coded aperture, light field post-processing techniques, high frequency optimization, optical triangulation and ultrasonic ranging

In exemplary embodiments, the imaging system 206 includes a camera that is used to capture the fingerprint data. In various embodiments, the camera may be a video camera or a photographic camera that is configured to capture images in color, gray scale, infrared, or near infra-red. In various embodiments, the camera may have a wide variety of resolutions based on the desired operating parameters of the imaging system. For example, the camera may be a low resolution camera that uses stitching to process the captured images. In another example, the camera may include a linear array of cameras that utilize scanning or motion detection algorithms.

In exemplary embodiments, the camera of the imaging system 206 includes a lens that may include, but not limited to, a zoom lens, a fixed power lens, a fixed focus lens, a variable focus lens, a variable focus and zoom lens, a conjugate focus lens, a telecentric lens, a zoom telecentric lens, a hypercentric lens, and a diffractive lens. In exemplary embodiments, the camera lens may include a lens drive that is used to adjust the focus or zoom of the lens. For example, the lens drive may be integral to the camera or may be an external drive system.

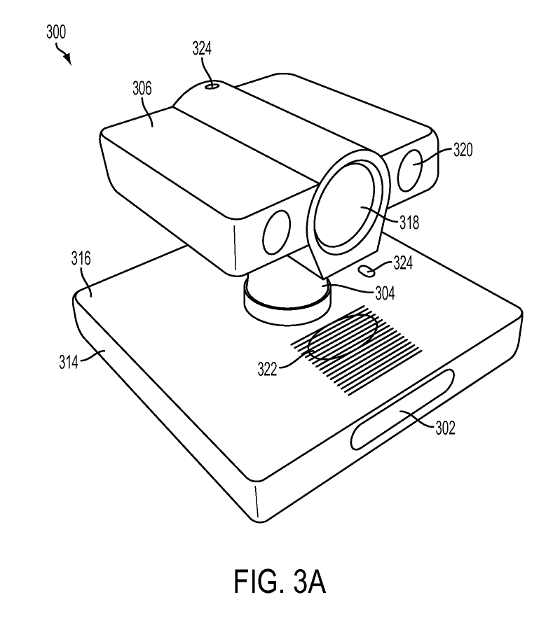

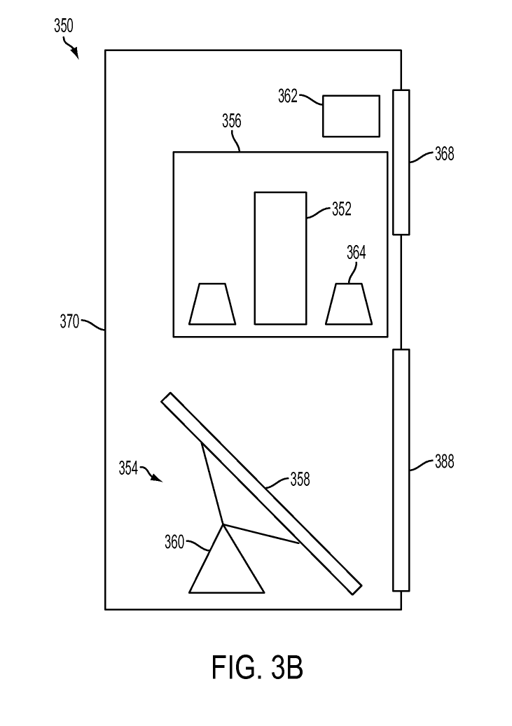

Referring now to FIG. 3A an agile non-contact biometric sensor apparatus 300 in accordance with an exemplary embodiment is shown. As illustrated, the agile non-contact biometric sensor apparatus 300 includes a sensor 302 configured to detect the presence and position of a hand in a field of view of the sensor 302. The agile non-contact biometric sensor apparatus 300 also includes an imaging system 306 that is mounted on a pan-tilt device 304. In exemplary embodiments, the pan-tilt device 304 is disposed on a base 314, which includes the sensor 302 and a cover 316. In exemplary embodiments, the imaging system 306 includes a camera 318 and may include one or more lights 320. The agile non-contact biometric sensor apparatus 300 may also include a speaker 322 and one or more indicator lights 324. In exemplary embodiments, the speaker 322 may be disposed in the base 314 and the cover 316 may include apertures disposed adjacent to the speaker 322.

In exemplary embodiments, a wide variety of cameras 318, including video and still cameras, may be used as the camera 318. The camera 318 may include a zoom lens that is selected to provide a sufficient field of view when zoomed out, and a selected number of pixels/inch when zoomed in. The magnification capability of the zoom lens and the resolution of the camera 318 are selected depending on the standards and requirements for the resolution of the fingerprint. In one embodiment, the zoom lens may be controlled by moving a ring attached to the zoom lens with and belt driven by a zoom motor. In another embodiment, the zoom lens may include a built in power zoom system. In exemplary embodiments, the imaging system 306 may include multiple cameras 318 that have different resolutions, focal lengths and zooming capabilities.

In one embodiment, the lights 320 of the imaging system 306 may include two LED white lights with lenses. In other embodiments, other suitable number and source of light can be used, such as incandescent lights, fluorescent lights, flash lights, strobe lights, and constant plus flash lights. In exemplary embodiments, the lights 320 can be cycled on and off in synchronization with frame capture of camera 318.

In exemplary embodiments, the imaging system 306 of the agile non-contact biometric sensor apparatus 300 may include a high resolution camera 318, which may reduce the amount of movement required by the pan-tilt device 304. For example, if the camera 318 has a sufficiently high resolution, the camera 318 may not need to be repositioned and zoomed in on the location of the hand in order to obtain fingerprint images of sufficient quality for extracting the fingerprint data. In one embodiment, the imaging system 306 may use a stack focusing algorithm to select a few of the captured images to provide a larger depth of field focus. In another embodiment, the imaging system 306 may use a high dynamic range algorithm that captures multiple images at multiple exposures and merges the images into a single high dynamic range images.

Referring now to FIG. 3B an agile non-contact biometric sensor apparatus 350 in accordance with an exemplary embodiment is shown. As illustrated, the agile non-contact biometric sensor apparatus 350 includes a housing 370 having one or more windows 368, 388. The agile non-contact biometric sensor apparatus 300 includes a sensor 362 configured to detect the presence and position of a hand in a field of view of the sensor 362. In exemplary embodiments, the sensor 362 may be completely or partially disposed within the housing 370. The agile non-contact biometric sensor apparatus 350 also includes an imaging system 356 and a pan-tilt device 354. In exemplary embodiments, the pan-tilt device 354 includes a mirror 358 that is mounted on a base 360. In exemplary embodiments, the imaging system 356 includes a camera 352 and may include one or more lights 364. Upon detecting the presence and position of a hand in a field of view the sensor 362, a signal indicative of the position of the hand is provided to the imaging system 356 and to the pan-tilt device 354. In exemplary embodiments, the signal may be directly provide to the imaging system 356 and to the pan-tilt device 354 by the sensor 362 or the sensor 362 may provide the signal to a processor (not shown) which in turn provides signals indicative of the position of the hand is provided to the imaging system 356 and to the pan-tilt device 354. Based on the signals received, the imaging system 356 adjusts a focus and zoom of the imaging system 356 based on the location of the hand and the pan-tilt device 354 adjusts the tilt of the mirror 358 to ensure the imaging system 356 is capturing the desired location in the field of view. In this embodiment, the amount of moving equipment is reduced, and only mirror 358 is moved by pan-tilt apparatus 354. The movement of the mirror 358 simultaneous moves the direction of the light illumination from lights 364 and the field of view of the camera 352. One advantage of this embodiment is the reduction of the number of moving parts, no wires subject to bending, and no external apparatus motion.

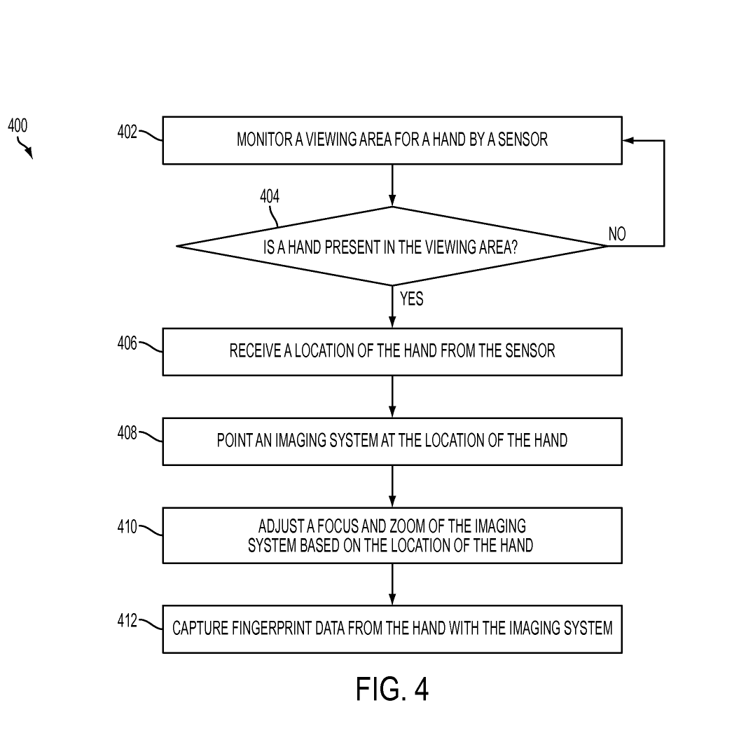

Referring now to FIG. 4 a flowchart diagram illustrating a method 400 for capturing fingerprint data with an agile non-contact biometric sensor apparatus in accordance with an exemplary embodiment is shown. As illustrated at block 402, the method 400 includes monitoring a field of view for a hand by a sensor. Next, as shown at decision block 404, the method 400 includes determining if a hand is present in the field of view. If a hand is detected in the field of view, the method 400 proceeds to block 406 and includes receiving the location of the hand from the sensor. If a hand is not detected in the field of view, the method returns to block 402 and continues monitoring the field of view for a hand by the sensor. Next, as shown at block 408, the method 400 includes pointing the imaging system at the location of the hand. In exemplary embodiments, the imaging system is mounted on a pan-tilt device that is used to control the orientation of the imaging system.

Continuing with reference to FIG. 4, as shown at block 410, the method 400 includes adjusting a focus and zoom of the imaging system based on the location of the hand. In exemplary embodiments the method 400, may also include illuminating the hand with one or more lights of the imaging system. Next, as shown at block 412, the method 400 includes capturing fingerprint data from the hand with the imaging system. In exemplary embodiments, capturing fingerprint data from the hand with the imaging system includes taking an image of the hand with a camera and using the pan-tilt device to further adjust the position of the camera such that a center the fingertip in the field of view. Capturing fingerprint data from the hand with the imaging system also includes adjusting a zoom of the camera to the correct scale. In exemplary embodiments, capturing fingerprint data from the hand with the imaging system may include varying a focus of the lens of the camera and acquiring an image at each focus position.

In exemplary embodiments, the agile non-contact biometric sensor apparatus may be configured to capture facial images in addition to fingerprint data. The facial image can then be stored and used along side the fingerprint data. In one embodiment, the agile non-contact biometric sensor apparatus may perform a facial recognition algorithm on the captured facial image.

In exemplary embodiments, the imaging system of the agile non-contact biometric sensor apparatus is configured to distinguish fingers from a background in order to identify the fingers. In one embodiment, a known background can be used to simplify the process of distinguish fingers from background. In cases where the background behind the users hand can be controlled, the color of background may be specified know by the imaging system. For example, a colored screen, such as a “green screen”, can be placed behind the hand. The “green screen” is a technique known in the industry, where portion of the image that is green is switched to another image source. In the current application, the non-green portions of the image will contain the hand and can be easily selected for further processing. In another embodiment, the imaging system of the agile non-contact biometric sensor apparatus may be configured to locate fingers in a field of view by performing color processing, that is, looking for portion of the field of view which contains a color normally associated with human skin. In a further embodiment, the imaging system of the agile non-contact biometric sensor apparatus may be configured to locate fingers in a field of view by performing shape or edge detection.

In exemplary embodiments, the agile non-contact biometric sensor apparatus includes a user interface that can be used to guide a user through an enrollment process. The user interface can include, but is not limited to, a display screen, a keyboard, a touch screen display, a speaker, a microphone, or the like. In exemplary embodiments, the enrolment process may be used to create a user profile that can include the user's identification information, which may include, but is not limited to, the user's name, title, fingerprint data, facial recognition data, birthdate, hire date, security clearance level, and the like.

In one embodiment, the enrollment process is an automated process in which the non-contact biometric sensor apparatus prompts the user to provide requested information and to position their hand so their fingerprint data can be captured. The non-contact biometric sensor apparatus is capable of performing the enrollment process in a variety of language and though various medium. For example, a user may elect to say their name but prefer to enter sensitive data, such as a social security number, through a text input method. During collection of the user's biometric data, the non-contact biometric sensor apparatus is configured to verify that the collected data is of sufficient quality and will re-capture the data if it is of poor quality.

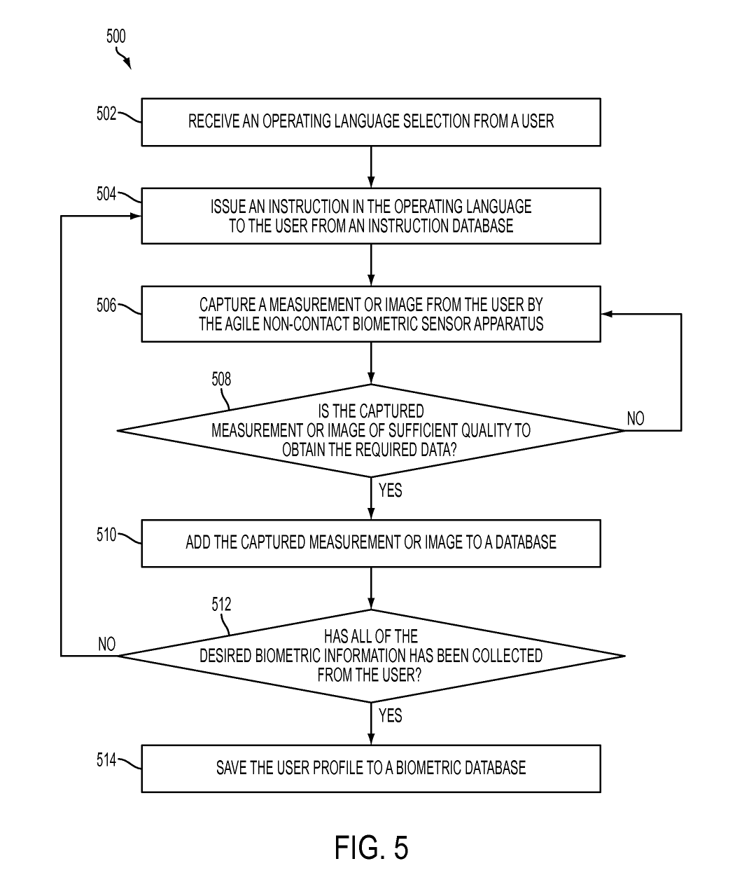

Referring now to FIG. 5, a flowchart diagram of a method 500 for enrollment in a biometric database using an agile non-contact biometric sensor apparatus in accordance with an exemplary embodiment is shown. As illustrated at block 502, the method 500 includes receiving an operating language selection from a user. Next, as shown at block 504, the method 500 includes issuing an instruction in the operating language to the user from an instruction database. In exemplary embodiments, the instruction may include an instruction to place a user's hand in a specified position and or location. As shown at block 508, the method 500 includes capturing a measurement or image from the user by the agile non-contact biometric sensor apparatus. Next, as shown at decision block 508, the method 500 includes determining if the captured measurement or image is of sufficient quality to obtain the required data. If the captured measurement or image is of sufficient quality to obtain the required data, the method 500 proceeds to block 510 and adds the captured measurement or image to a database. Otherwise, the method 500 returns to block 508 and recaptures the measurement or image from the user by the agile non-contact biometric sensor apparatus. In exemplary embodiments, recapturing the measurement or image from the user may also include instructing the user to place their hand in a specified position and or location.

Continuing with reference to FIG. 5, as shown at decision block 512, the method 500 includes determining if all of the desired biometric information has been collected from the user. If not all of the desired biometric information has been collected from the user, the method 500 returns to block 504 and issues another instruction to the user from the instruction database. Otherwise, the method proceeds to block 514 and saves the user profile to a biometric database.

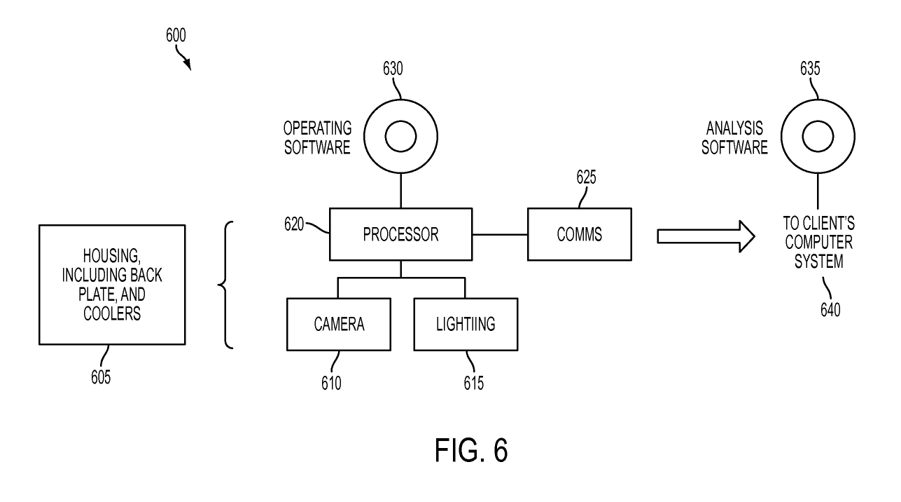

FIG. 6 illustrates a system level diagram of an exemplary contactless fingerprint acquisition and processing system 600. The system 600 can include various housing structures 605 for the components described herein. The system 600 can further include a camera 610 and lighting 615 as described herein. The camera 610 and the lighting 615 can be operatively coupled to a processor 620 as described herein. The processor 620 can further be coupled to a communications module 625. The processor 620 can further include various operating software as described herein. The communications module 625 can be coupled to a client computer 640 that can include analysis software 635, which can also reside on the processor 620.

The computer (see FIG. 1 for example) described herein is now described in further detail. The following computing system can also describe any suitable computing system such as a fingerprint server and client computing system described herein.

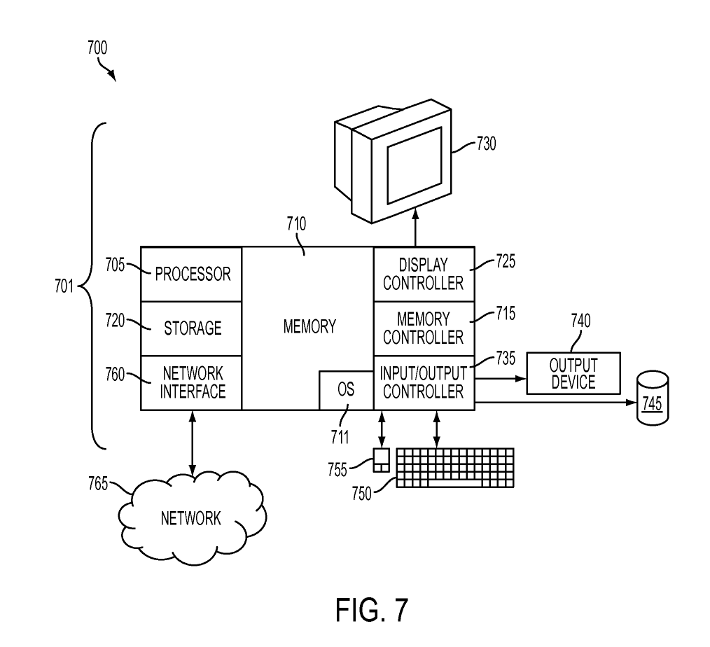

FIG. 7 illustrates an exemplary embodiment of a system 700 for acquiring and processing contactless finger/palm prints. The methods described herein can be implemented in software, firmware, hardware, or a combination thereof. In exemplary embodiments, the methods described herein are implemented in software, as an executable program, and is executed by a special or general-purpose digital computer, such as a personal computer, workstation, minicomputer, or mainframe computer. The system 700 therefore includes general-purpose computer 701.

In exemplary embodiments, in terms of hardware architecture, as shown in FIG. 7, the computer 701 includes a processor 705, memory 710 coupled to a memory controller 715, and one or more input and/or output (I/O) devices 740, 745 (or peripherals) that are communicatively coupled via a local input/output controller 735. The input/output controller 735 can be, but is not limited to, one or more buses or other wired or wireless connections, as is known in the art. The input/output controller 735 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 705 is a hardware device for executing software, particularly that stored in memory 710. The processor 705 can be any custom made or commercially available processor, a central processing unit (CPU), an auxiliary processor among several processors associated with the computer 701, a semiconductor based microprocessor (in the form of a microchip or chip set), a macroprocessor, or generally any device for executing software instructions.

The memory 710 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, and/or other types of storage media. Note that the memory 710 can have a distributed architecture, where various components are situated remote from one another, but can be accessed by the processor 705.

The software in memory 710 may include one or more separate programs, each of which comprises an ordered listing of executable instructions for implementing logical functions. In the example of FIG. 7, the software in the memory 710 includes the contactless fingerprint acquisition and processing methods described herein in accordance with exemplary embodiments and a suitable operating system (OS) 711. The OS 711 essentially controls the execution of other computer programs, such the contactless fingerprint acquisition and processing systems and methods as described herein, and provides scheduling, input-output control, file and data management, memory management, and communication control and related services.

The contactless fingerprint acquisition and processing methods described herein may be in the form of a source program, executable program (object code), script, or any other entity comprising a set of instructions to be performed. When a source program, then the program needs to be translated via a compiler, assembler, interpreter, or the like, which may or may not be included within the memory 710, so as to operate properly in connection with the OS 711. Furthermore, the contactless fingerprint acquisition and processing methods can be written as an object oriented programming language, which has classes of data and methods, or a procedure programming language, which has routines, subroutines, and/or functions.

In exemplary embodiments, a conventional keyboard 750 and mouse 755 can be coupled to the input/output controller 735. Other output devices such as the I/O devices 740, 745 may include input devices, for example but not limited to a printer, a scanner, microphone, and the like. Finally, the I/O devices 740, 745 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. For example, FIG. 19 shows the inclusion of a proximity card reader. Other devices such as a PIN keypad, microphone for voice analysis, camera for iris scan, or other biometric identifier should be included. The system 700 can further include a display controller 725 coupled to a display 730. In exemplary embodiments, the system 700 can further include a network interface 760 for coupling to a network 765. The network 765 can be an IP-based network for communication between the computer 701 and any external server, client and the like via a broadband connection. The network 765 transmits and receives data between the computer 701 and external systems, such as external fingerprint servers as described herein. In exemplary embodiments, network 765 can be a managed IP network administered by a service provider. The network 765 may be implemented in a wireless fashion, e.g., using wireless protocols and technologies, such as WiFi, WiMax, etc. The network 765 can also be a packet-switched network such as a local area network, wide area network, metropolitan area network, Internet network, or other similar type of network environment. The network 765 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 701 is a PC, workstation, intelligent device or the like, the software in the memory 710 may further include a basic input output system (BIOS) (omitted for simplicity). The BIOS is a set of essential software routines that initialize and test hardware at startup, start the OS 711, and support the transfer of data among the hardware devices. The BIOS is stored in ROM so that the BIOS can be executed when the computer 701 is activated.

When the computer 701 is in operation, the processor 705 is configured to execute software stored within the memory 710, to communicate data to and from the memory 710, and to generally control operations of the computer 701 pursuant to the software. The contactless fingerprint acquisition and processing methods described herein and the OS 711, in whole or in part, but typically the latter, are read by the processor 705, perhaps buffered within the processor 705, and then executed.

When the systems and methods described herein are implemented in software, as is shown in FIG. 7, the methods can be stored on any computer readable medium, such as storage 720, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the contactless fingerprint acquisition and processing methods are implemented in hardware, the contactless fingerprint acquisition and processing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include the ability to acquire fingerprint images at varying distances. The systems and methods described herein further provide identification and verification of individual fingerprints, providing both an indication to whom the fingerprint belongs as well as a confirmation of whether a fingerprint is the fingerprint of the individual asserting to be a certain person.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An agile non-contact biometric sensor apparatus, comprising:
a sensor that monitors a field of view for a user;
an imaging system that captures one or more pieces of biometric information from the user; and
a pan-tilt device that orients the imaging system to a location of the user in the field of view detected by the sensor.

2. The agile non-contact biometric sensor apparatus of claim 1, further comprising a processor configured to receive an indication of the location of user in the field of view from the sensor.

3. The agile non-contact biometric sensor apparatus of claim 3, wherein the processor is further configured to provide the pan-tilt device with the location of user in the field of view from the sensor.

4. The agile non-contact biometric sensor apparatus of claim 1, wherein the imaging system is a contactless fingerprint acquisition device.

5. The agile non-contact biometric sensor apparatus of claim 2, wherein the sensor detects a presence of a hand of the user inside the field of view and responsively provides a signal to the processor that indicates a location of the hand in the field of view.

6. The agile non-contact biometric sensor apparatus of claim 2, wherein the processor provides the imaging system with the location of the user in the field of view and the imaging system responsively adjusts one or more operation parameters of the imaging system.

7. The agile non-contact biometric sensor apparatus of claim 6, wherein the one or more operation parameters of the imaging system comprise an optical zoom, a digital zoom, and a focus.

8. A method for capturing fingerprint data with an agile non-contact biometric sensor apparatus, comprising:
monitoring a field of view for a hand by a sensor of the agile non-contact biometric sensor apparatus;
based on determining that the hand is present in the field of view:
receiving a location of the hand from the sensor;
pointing an imaging system of the agile non-contact biometric sensor apparatus at the location of the hand; and
capturing fingerprint data from the hand with the imaging system.

9. The method of claim 8, further comprising based on determining that the hand is present in the field of view adjusting a focus and zoom of the imaging system based on the location of the hand.

10. The method of claim 8, wherein the imaging system is a contactless fingerprint acquisition device.

11. The method of claim 8, wherein the imaging system is mounted on a pan-tilt device that controls an orientation of the imaging system.

12. The method of claim 8, further comprising comparing the captured fingerprint data with one or more records of a database of known fingerprints.

13. The method of claim 11, wherein capturing fingerprint data from the hand with the imaging system comprises taking an image of the hand with a camera of the imaging system and using the pan-tilt device to adjust a position of the camera such that a center of a fingertip of the hand is in the field of view.

14. The method of claim 8, wherein capturing fingerprint data from the hand with the imaging system comprises varying a focus of a lens of a camera of the imaging system and acquiring an image at each focus position.

15. A computer program product having a non-transitory computer readable medium storing instructions for causing a computer to perform a method for capturing fingerprint data with an agile non-contact biometric sensor apparatus, the method comprising:
monitoring a field of view for a hand by a sensor of the agile non-contact biometric sensor apparatus;
based on determining that the hand is present in the field of view:
receiving a location of the hand from the sensor;
pointing an imaging system of the agile non-contact biometric sensor apparatus at the location of the hand; and
capturing fingerprint data from the hand with the imaging system.

16. The method of claim 15, further comprising based on determining that the hand is present in the field of view adjusting a focus and zoom of the imaging system based on the location of the hand.

17. The method of claim 15, wherein the imaging system is a contactless fingerprint acquisition device.

18. The method of claim 15, wherein the imaging system is mounted on a pan-tilt device that controls an orientation of the imaging system.

19. The method of claim 15, further comprising comparing the captured fingerprint data with one or more records of a database of known fingerprints.
